(19) United States
(12) Patent Application Publication
(10) Pub. No.: US 2002/0083306 A1
(43) Pub. Date: Jun. 27, 2002

(54) Digital signal processing apparatus

(76) Inventors: Francesco Pessolano, Eindhoven (NL); Jozef Laurentius Wilhelmus Kessels, Eindhoven (NL); Adrianus Marinus Gerardus Peeters, Eindhoven (NL)

Correspondence Address: U.S. Philips Corporation, 580 White Plains Road, Tarrytown, NY, 10591, US

(21) Appl. No.: 10/020,019

(22) Filed: Dec. 7, 2001

(30) Foreign Application Priority Data
Dec. 7, 2000 (EP) 00310905.5

(51) Int. Cl. G06F 9/00

(52) U.S. Cl. 712/220

(57) ABSTRACT

The present invention relates to a digital signal processing apparatus for executing a plurality of operations, comprising a plurality of functional units (10) wherein each functional unit (10) is adapted to execute operations, and control means for controlling said functional units (10), wherein said control means comprises a plurality of control units (12) wherein at least one control unit (12) is operatively associated to any functional unit (10), respectively, for con-trolling its function, and each functional unit (10) is adapted to execute operations in an autonomous manner under control by the control unit (12) associated thereto, and/or wherein provided is a FIFO (first-in/fist-out) register means (14) adapted for supporting data-flow communication among said functional units (10). Further the present invention relates to a method for processing digital signals in digital signal processing apparatus comprising a plurality of functional units (10) wherein each functional unit (10) is adapted execute operations, and wherein said functional units (10) are controlled by a plurality of control units (12) wherein at least one control unit (12) is operatively associated to any functional unit (10), respectively, so that each functional unit (10) is able to execute operations in an autonomous manner under control by the control unit (12) associated thereto, and/or wherein data-flow communication among said functional units (10) is supported by FIFO (first-in/first-out) register means (14).

The present invention relates to a digital signal processing apparatus for executing a plurality of operations, comprising a plurality of functional units wherein each functional unit is adapted to execute operations, and control means for controlling said functional units. Moreover, the present invention relates to a method for processing digital signals in a digital signal processing apparatus comprising a plurality of a functional units wherein each functional unit is adapted to execute operations.

Such an apparatus and a method are usually implemented in digital signal processors (DSPs). To increase their performance, the digital signal processors contain several processing units which normally operate in small loops. Two conventional solutions exist, namely the provision of (1.) VLIW processors comprising several functional units and a central control, and (2.) a control processor with co-processors each of which performs a fixed function autonomously.

EP 0,403,729 A2 discloses a digital signal processing apparatus including two or more address registers associated with at least one of an instruction memory, a data memory or a coefficient memory, and two or more data registers associated with a computing block. These two or more registers are duty cycled switched between different jobs being simultaneously processed by the computing block to enable efficient processing on a single chip of jobs which can be processed with different processing speeds, such as jobs suited for high speed processing or low speed processing.

On pages 176 to 186 of the conference paper “Proceedings Sixth International Symposium on Advanced Research in Asynchronous Circuits and Systems (ASYNC 2000)” (Cat. No. PR00586), published 2000 in Los Alamitos, Calif., USA, Brackenbury describes an architecture for a low-power asynchronous digital signal processor to be provided for the target application of GSM (digital cellphone) chip sets. A key part of this architecture is an instruction buffer which both provides storage for prefetched instructions and performs hardware looping. This requires low latency and a reasonably fast cycle time, but must also be designed for low power. In this document, a design is presented based on a word-slice FIFO (first-in/first out) structure. This avoids the problem of input latency and power consumption associated with linear micro-pipeline FIFOs, and the structure lends itself reactively easily to the required looping behavior. The latency, cycle time and power consumption for this design are compared to those of a simple micropipeline FIFO. The cycle time for the instruction buffer is around three times slower than the micropipeline FIFO. However, the instruction buffer shows an energy per operation of between 48% to 62% of that for the (much less capable) micropipeline structure. The input to output latency with an empty FIFO is less than the micropipeline design by a factor of ten.

U.S. Pat. No. 5,655,090 A discloses an externally controlled digital signal processor with input/output FIFOs operating asynchronously and independently of a system environment. A means of making a digital signal processing function performs independently of the system processor and appears as a hardware FIFO. The architecture of this system comprises a digital signal processing means connected between the data output of a first FIFO buffer and the data input of a second FIFO buffer, a control means for controlling the digital signal processing means as a function of the presence and absence of data in the first FIFO buffer and the second FIFO buffer and control signals received from a source of control signals. Data throughput is performed asynchronously and independently of the system environment and comprises the following steps: Receiving data on the data input of the first FIFO buffer, transferring that data to the digital signal processor, processing the data, then transferring the processed data to the second FIFO buffer to be output when the data receiver is ready to accept the data.

In U.S. Pat. No. 5,515,329 A it is shown a memory system which exhibits data processing capabilities by the inclusion therein of a digital signal processor and an associated dynamic random access memory. The digital signal processor provides significant data processing on the fly while the dynamic random access memory array provides additional buffering capability. Input and output FIFOs are connected to the data and address busses of the digital signal processor. The control of the digital signal processor is via a host processor connected to the digital signal processor by a serial communication link.

U.S. Pat. No. 5,845,093 A discloses a digital signal processor on an integrated circuit which processor uses a multi-port data flow structure characterized by four ports, referred to as an acquisition port, two data ports, and a coefficient port. All four ports may be bi-directional so that data may be read from and written to the respective ports by the DSP system. This architecture allows a data flow management scheme in which data enters the processor through the acquisition port, or any one of the data ports. As the data is processed, it may ping pong between the data ports, or between a data port and the acquisition port. At the end of a DSP algorithm, the output data may be provided through the acquisition port or a data port as suits the needs of the particular application. A coefficient port is typically used for providing coefficients or twiddle factors for DSP algorithms. Each data port is attached to dedicated independent data memory. This provides for optimization of multipass algorithms.

Sun has developed a multi-thread processor called “MAJC” which allows multiple threads to execute at the same time. In this processor, each functional unit receives instructions relative to one or more threads and executes them in sequence. The functional units are forced by a single control to execute instructions relative to the same thread at the same time. Autonomous tasks do not exist since threads execute in sequential alternation. However, the MAJC processor is not intended for processing in the above sense, but for network processing.

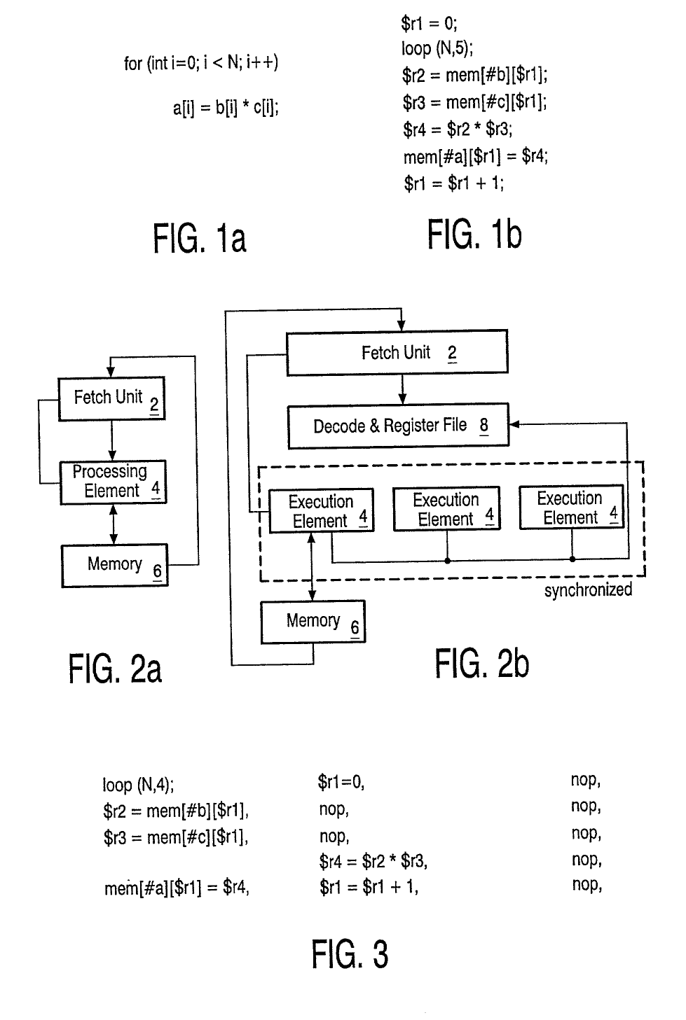

FIG. 1 shows a simple example of a digital signal processor (DSP) loop computing a vector product which well represents a wide class of DSP algorithms (e.g. FIR filtering). FIG. 1a shows the original C code which can be compiled into a generic assembly code of a generic DSP core which assembly code is shown is FIG. 1b.

A standard DSP core is shown as block diagram in FIG. 2a. The simplest standard DSP core executing the formerly mentioned code is a sequential machine (sometimes called scalar processor) which reads one instruction at a time and then executes it in a pipelined fashion. The flow of instructions is determined by a single control point-the fetch unit 2 (cf. FIG. 2a)-that determines which instruction to fetch from a memory 6 and issue for execution in a processing element 4.

Modern DSP cores try to break such sequential modus operandi by means of executing multiple instructions at a time. This is possible because some sequential instructions neither share resources nor exchange data, i.e. the are independent. The most popular of these approaches is based on the very large instruction word (VLIW) architecture. In this case, such instructions are grouped in bundles. Each bundle is fetched from a memory at a time, and the instructions in the same bundles are then executed synchronously, i.e. issued, decoded and executed concurrently. An example of block diagram of a VLIW DSP core is shown in FIG. 2b. From FIG. 2b it can be noticed that the fetch unit 2 presents the control point responsible for the flow of instructions in the same manner as in the simple DSP core of FIG. 2a.

The vector product of the computation shown in FIG. 1 for a VLIW DSP would look like the code given in FIG. 3. Bundles are composed by instructions separated by commas, whilst the bundles themselves are separated by semicolons. Even if the number of bundles is less than the number of instructions in the original code (cf. FIG. 1b vs. FIG. 3), the number of basic instructions has increased; in fact, it is not always possible to find independent instructions to fill the bundles, and a so-called “no-operation” (nop) instruction is thus required.

It is an object of the present invention to still further increase the performance and in particular to obtain a digital signal processing apparatus and method which combine the flexibility of a VLIW processor with the coarse grain parallelism offered by the provision of co-processors.

In order to achieve the above and further objects, there is provided in accordance with a first aspect of the present invention a digital signal processing apparatus for executing a plurality of operations at the same time, comprising a plurality of functional units wherein each functional unit is adapted to execute operations, and control means for controlling said functional units, characterized in that said control means comprises a plurality of control units wherein at least one control unit is operatively associated to any functional unit, respectively, for controlling its function, and each functional unit is adapted to execute operation in an autonomous manner under control by the control unit associated thereto. In accordance with a second aspect of the present invention, there is also provided a method for processing digital signals in a digital signal apparatus comprising a plurality of functional units wherein each functional unit is adapted to execute operations, characterized in that said functional units are controlled by a plurality of control units wherein at least one control unit is operatively associated to any functional unit, respectively, so that each functional unit is able to execute operations in an autonomous manner under control by the control unit associated thereto.

Accordingly, each functional unit has one dedicated control unit. In other words, each functional unit is provided with ‘private’ control means, giving each functional unit its own dedicated module to control its function. The functional units can either execute normal instructions (as in a conventional processor) or special ones (so-called directives) which make it execute a so-called process or task autonomously, wherein a process or task means the execution of a certain operation (one or more of its normal instructions) a specified number of times.

In order to achieve the above and further objects, there is provided in accordance with a third aspect of the present invention a digital signal processing apparatus for executing a plurality of operations, comprising a plurality of functional units wherein each functional unit is adapted to execute operations, and control means for controlling said functional units, characterized by FIFO (first-in/fist-out) register means adapted for supporting data-flow communication among said functional units. In accordance with a fourth aspect of the present invention, there is also provided a method for processing digital signals in a digital signal processing apparatus, comprising a plurality of functional units wherein each functional unit is adapted to execute operations, characterized in that data-flow communication among said functional units is supported by FIFO (first-in/first-out) register means.

Of course, both the above first and third aspects and both the above second and fourth aspects of the present invention can be combined together, respectively, so as to also provide a digital signal processing apparatus and a method for processing digital signals comprising the distributed control by local control units per functional unit as well as the data-flow support by means of FIFOs.

In comparison with a conventional VLIW processor, the advantages of the invention are better scalability and higher performance due to task level parallelism which makes it easier to keep the functional units busy. Further, less program memory accesses are needed which result in lower power and memory band width (maxi-mum number of accesses per time unit that a memory supports).

In comparison with other current digital signal processors, such as the Philips “R.E.A.L.” digital signal processor, the present invention has the advantage that it is simpler for the compiling since the instruction set is regular and no customizable VLIW, i.e. ASIs for the above mentioned processors are needed.

After all, the present invention provides a solution which combines the flexibility of VLIW processors with the coarse grain parallelism offered by co-processors.

In accordance with the present invention, the operations can be executed independently, in parallel, concurrently and/or at the same time. Further, an asynchronous implementation of the architecture a synchronous implementation of the architecture or a mixed implementation are optionally possible with the present invention.

In case of the provision of FIFOs in accordance with the present invention, such FIFOs can be configurable. Usually the digital processor apparatus comprises a register file so that such register file can be extended with the FIFO register means wherein the FIFO register means can have separate addresses or be part of the register file. So, in addition to the conventional registers there can be the FIFO register means. Usually, the FIFO register means comprises a plurality of FIFO registers. Accordingly, the register file can be extended with a number of FIFOs supporting the data-flow communication among the functional units. Here it should be noted that the difference between a register and a FIFO is that a FIFO has means to ‘synchronize’ the sender and the receiver.

Preferably, a pipeline consisting of a plurality of stages is provided, and each stage is executed by a functional unit. In particular, by connecting subtasks through FIFOs a pipeline can be formed at software level.

The FIFOs between the functional units can be used not only for the flow of data through the thus formed pipeline, but also for the flow of control. An example of how this can be exploited is when in the pipelines of functional units each unit has to perform the same number of operations. Only the head of the pipeline needs to know this number, and it may be data dependent. The other functional units might learn about the end-of-data by inspecting e.g. an extra bit which is added to the data in the FIFO. Another example is if the number of repetitions is unknown in some functional units, such as when samples may have to be added or thrown away occasionally.

It is to be noted that the prologue and the epilogue for setting up a pipeline in a VLIW processor is not needed since it comes naturally from the FIFO synchronization. For explanation purposes as an example it is assumed to use a VLIW processor for executing a pipeline consisting of e.g. three stages wherein each stage is executed by a functional unit called F1, F2, and F3, respectively. For instance, F1 reads values from a memory and passes them on to F2. F2 does a computation and transfers the result to F3. F3 writes the results back into the memory. At full speed, all three functional units in this example perform their function concurrently controlled by one VLIW instruction. Before the loop starts, however, there are two instructions to initialize the loop, namely first an instruction for F1 and subsequently an instruction for F1 and F2 (what is called the prologue). After the loop, there is a similar situation in that the pipeline has to be emptied by executing first an instruction for F2 and F3 and finally an instruction F3 (what is called the epilogue). As already mentioned above, in the architecture of the present invention such a prologue and epilogue are not needed. Rather, the architecture of the present invention supports instruction level parallelism in pipelines (the subtasks in the pipeline communicate on instruction level) as well as task level parallelism (several pipelines can be active mutually simultaneously as well as simultaneously with the main thread).

In a still further preferred embodiment of the present invention, for each control unit an instruction register and a counter are provided, wherein the counter indicates the number of times an instruction stored in the instruction register has to be executed by the corresponding functional unit. The instruction register holds one operation or a sequence of operations, and the counter indicates how often the operation still has to be executed. Further, the control units can usually include address registers, too. The counter can be implemented as a separate device or as a part of the associated control unit. However, other constructions are possible as well; e.g. an XOR based operation (using a Galois Field representation) and an up-counting until a bound is reached are equally powerful, too.

In a still further preferred embodiment of the present invention, wherein a program memory means is provided for storing a main program, the main program contains directives for instructing the control units. According to the present invention, the functional units have their own control logic, as already pointed out above, and the main program contains directives to instruct this control logic (e.g. saying “execute this operation n times”). So, usually there is a central control which contains a program counter for the main program. This central control is called master control unit, whereas the control units of the functional units are called slave control units. The master control unit fetches the instructions and instructs the slave control units, accordingly. As soon as the central or master control unit has set up a pipeline, it can proceed and for instance start another pipeline; this kind of parallelism is called task level parallelism. So, the decentralized control of the functional units according to the present invention supports the instruction level parallelism, whereas the central control can take care of the task level parallelism (hierarchical control structure).

With respect to the encoding of the instructions such as stored in local memories in the local control units, it is noted that this encoding can be chosen independently of the encoding of the instruction in the main instruction stream such as observed by the central control. For instance, a ‘narrow’ encoding can be chosen since less bits are required to encode the options of the local control unit than of the arsenal of local control units. So, given that processes use only the basic operations of a given local control unit, the local control unit itself stores only a shorter version of the instructions in the processes as given from the directive itself. Another option is to let the central control send partially decoded instructions to the local control units which instructions potentially contain more bits.

The above and other objects and features of the present invention will become clear from the following description taken in conjunction with the preferred embodiments with reference to the accompanying drawings in which:

FIG. 1 shows a simple example of DSP loop computing vector product, expressed as C code (a) and as generic assembly code (b);

FIG. 2 shows block diagrams of a standard DSP core (a) and of a modem VLIW DSP core (b);

FIG. 3 shows the vector product loop for a VLIW DSP core;

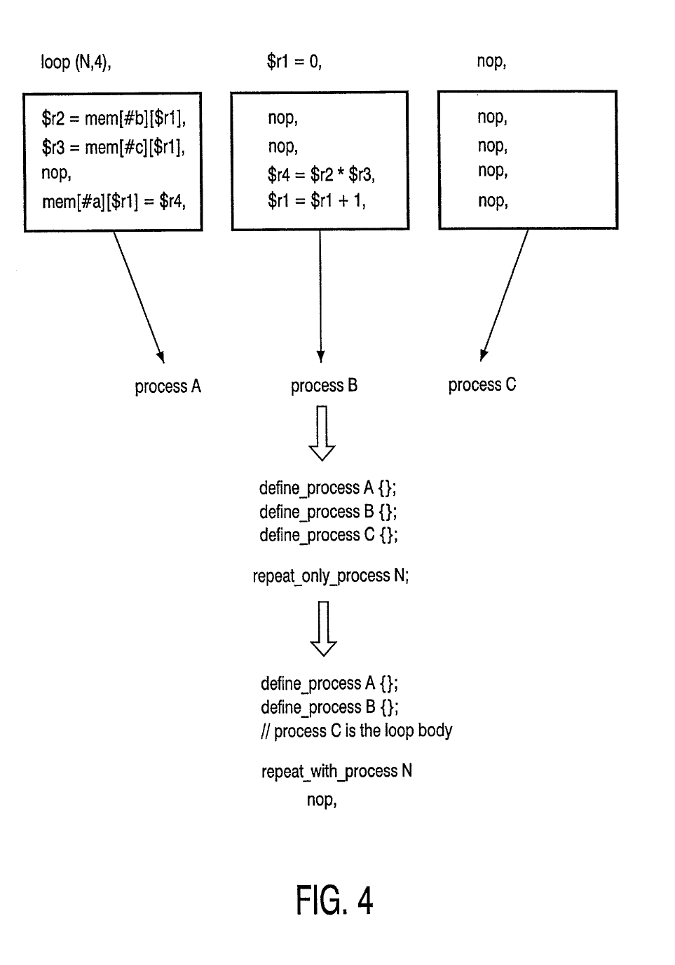

FIG. 4 shows an example of identification of processors and final appearance of the code;

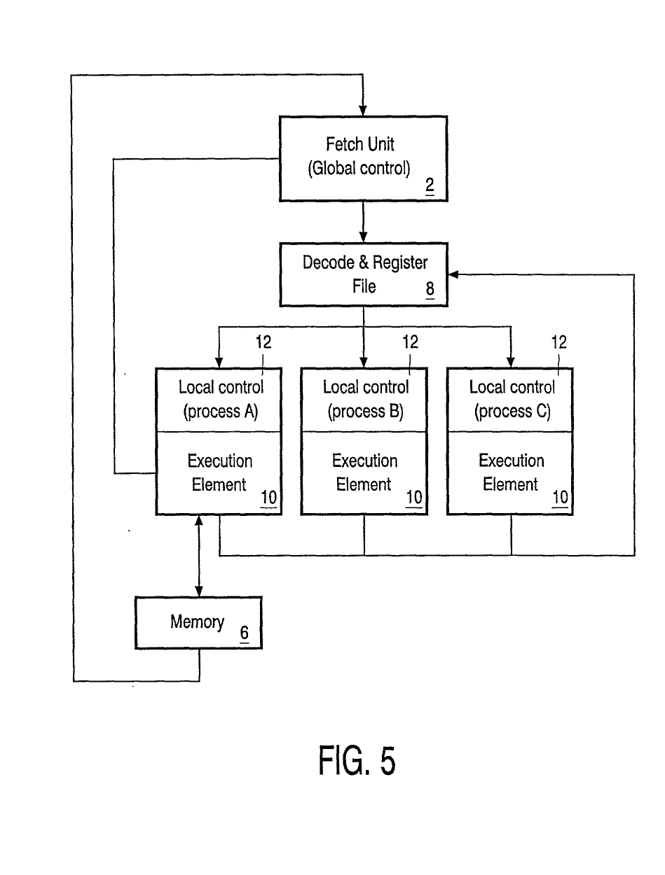

FIG. 5 shows a block diagram of a DSP using local control logic without FIFO registers;

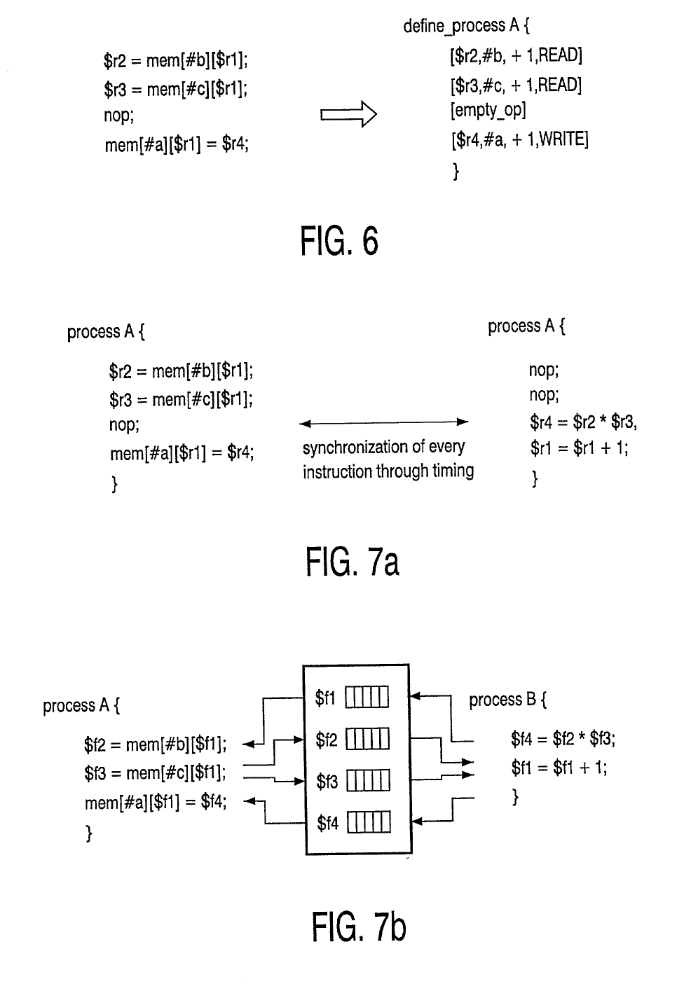

FIG. 6 shows an example of definition of a process using local control and central resources;

FIG. 7 shows an example of a process using local control alone which requires timing synchronization in the manner of VLIW DSP cores yet (a) and using local control and FIFO registers for moving synchronization on the data-flow so as to simplify the process definition and reduce the number of required instructions (b);

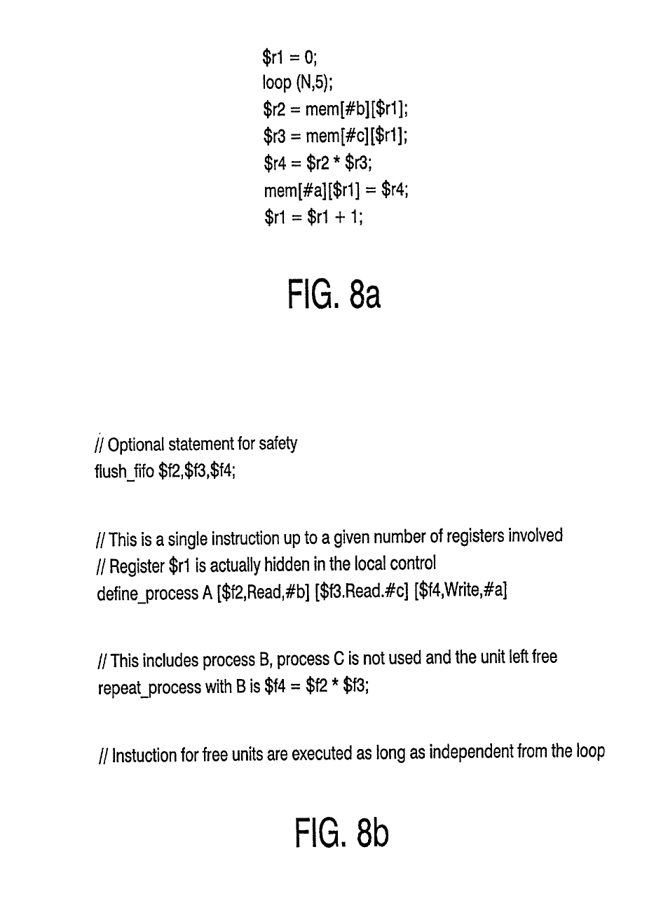

FIG. 8 shows the vector product for an original standard DSP core (a) and a possible version of the same piece of code for a DSP using local control and FIFO registers (b); and

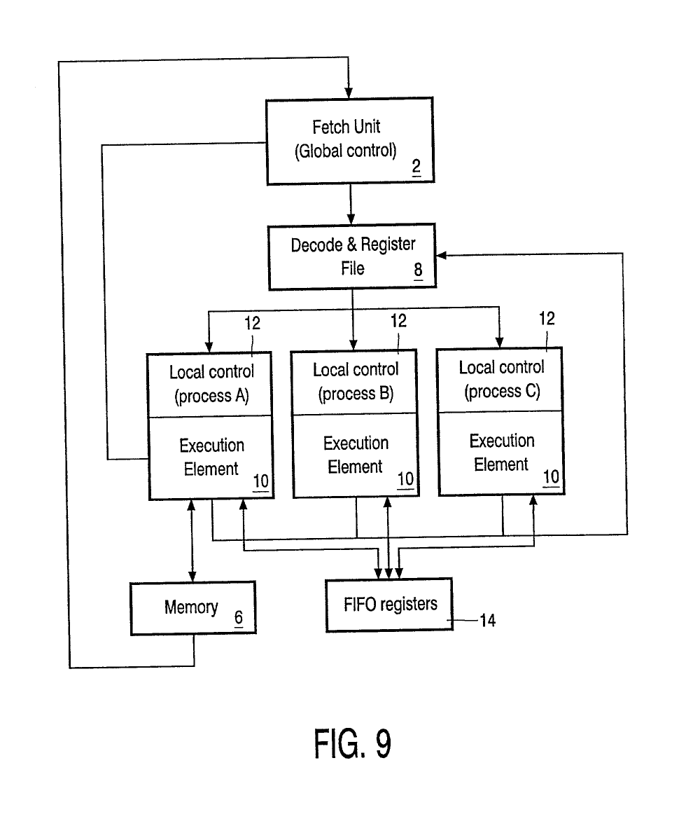

FIG. 9 shows a block diagram of a DSP using local control logic together with FIFO registers.

The code in FIG. 3 suggests that each functional unit is actually working only on a subset of the given code. If the body of the loop is isolated, three tasks or processes could actually be identified which are executed by the three functional units, respectively. These are referred to as processes A, B and C (cf. FIG. 4). Further, it is assumed that each process is always executed by the same functional unit of the DSP core.

Shown in FIG. 5 is a DSP core which is similar to the DSP core of FIG. 2b but differs therefrom in that each functional unit (named execution element 10 in FIG. 5) is provided with a private control logic (named local control 12 in FIG. 5) which control logic can execute a given process for a certain number of times. Each local control 12 includes an instruction register or memory holding one operation or a sequence of operations, a counter indicating how often the operation still has to be executed and perhaps address registers (note that the construction of the local control is not shown in FIG. 5). In addition to the private control logic or local control 12 associated to each functional unit or execution element 10, there is provided a central control logic (named global control in FIG. 5) in the fetch unit 2. The fetch unit 2 of the standard or modem VLIW DSP cores shown in FIG. 2 already includes such a central control logic as the only control means. The control logic is thus normally centralized as for standard or modem VLIW DSP cores (FIG. 2), namely one instruction is fetched at a time and then issued to one functional unit or execution element. However, in the DSP core shown in FIG. 5, when a loop is initiated, control is transferred to the local control 12 of the respective execution element 10.

Besides local control, support to specify processes must be included. Simple instructions are provided to specify a process in a simple and compact way as long as it includes only simple operations like e.g. load, store and multiplication (cf. FIG. 6). Processes are always defined before the loop is initiated. However, it may be the case that one of the processes (e.g. C in FIG. 4) is defined by the loop itself. When processes have been completed, control is transferred to the fetch unit. This solution reduces the number of instructions in the loop body generally resulting in reduced access to external instruction memory and sometimes transforming the loop into a repeat statement which accesses the instruction memory only once. This leads to reduced power consumption and faster operation with no sensible effect on code dimension. Besides, the local control takes care of the indexes used in the loop by means of local registers (hidden to the programmer) thus reducing register pressure; e.g. in FIG. 6 the register $rl is actually not used to specify the process, but instead its increment +1 is specified.

The adoption of local control may, however, require that instructions are executed in a particular order in time corresponding to the synchronization among instructions in the same bundle of VLIW DSP cores (cf. FIG. 7a). Therefore, all functional units or execution elements are involved in each loop. In order to relax such constraint, synchronization to data is deferred. The instruction in the process which is waiting for a new data is stalled only. In order to easily include such synchronization on data, added to the provision of local controls are first-in/first-out (FIFO) queues used in the manner of registers (referred to as $f in the example of FIG. 7 instead of $r as for standard registers in the example of FIG. 3 and 6). An instruction writing in a FIFO register is stalled only if the FIFO is full while an instruction reading a FIFO register is stalled only if data is not available. In this way, as shown in FIG. 7b, instructions exchange data through the FIFOs, and no additional “nop” instruction is required in the process. Synchronization data allows processes to be executed out-of-order in the manner of a super-scalar processor.

FIG. 8 illustrates a possible code for implementing the vector product loop in the original standard DSP core (a) and in DSP core using local control and FIFO registers (b). In accordance with FIG. 8a, each instruction would be coded in 32-bit. However, according to FIG. 8b the “define_process” directive specifies a 3-instruction process. The directive itself is 32-bit and the local control 12 (cf. FIG. 5) stores only its information which is 18-bit (instead of 96-bit which would be required according to FIG. 8a). The register holding address #b stores in its tag the information {$f3, Read, first_instruction } and so on. Of course, the size of the tag depends on how this information is coded and complex.

FIG. 9 shows a DSP core having the same construction as that of FIG. 5, but is additionally provided with FIFO registers 14.

As it becomes clear from FIG. 8 when compared with FIG. 3 and 4, the final code is shorter than the original; it replaces the loop statement with a repeat one which defines the repeat body as process B. Due to both synchronization on data and local control, all functional units or execution elements free of processes, where a process is either completed or not used (as process C), transfer control to the fetch unit and then can execute the instructions subsequent to the loop itself in parallel with the loop itself. This is not possible in standard solutions (e.g. conventional VLIW DSP) where in fact the units not involved in computation are either stalled or executing “nop” operations in order to respect timing constraints.

1. A digital signal processing apparatus for executing a plurality of operations, comprising
a plurality of functional units (10) wherein each functional unit (10) is adapted to execute operations, and
control means for controlling said functional units (10), characterized in that said control means comprises a plurality of control units (12) wherein at least one control unit (12) is operatively associated to any functional unit (10), respectively, for controlling its function, and each functional unit (10) is adapted to execute operations in an autonomous manner under control by the control unit (12) associated thereto.

2. Apparatus according to claim 1, characterized by FIFO (first-in/fist-out) register means (14) adapted for supporting data-flow communication among said functional units (10).

3. A digital signal processing apparatus for executing a plurality of operations, comprising
a plurality of functional units (10) wherein each functional unit (10) is adapted to execute operations, and
control means for controlling said functional units (10), characterized by FIFO (first-in/fist-out) register means (14) adapted for supporting data-flow communication among said functional units (10).

4. Apparatus according to claim 2 or 3, comprising a register file (8) characterized in that said register file (8) is extended with said FIFO register means (14).

5. Apparatus according to any one of claims 2 to 4, characterized in that said FIFO register (14) means comprises a plurality of FIFO registers.

6. Apparatus according to at least one of the preceding claims, characterized in that each of said functional units (10) are provided with at least one control unit (12).

7. Apparatus according to at least one of the preceding claims, which apparatus is adapted to execute a pipeline consisting of a plurality of stages, wherein each stage is executed by a functional unit (10).

8. Apparatus according to at least one of the preceding claims, characterized in that for each control unit (12) an instruction register and a counter are provided, where-in said counter indicates the number of times an instruction stored in said instruction register has to be executed by the corresponding functional unit (10).

9. Apparatus according to at least any one of the proceeding claims, further comprising a program memory means (6) storing a main program, characterized in that said main program contains directives for instructing said control units.

10. A method for processing digital signals in a digital signal processing apparatus, comprising a plurality of functional units (10) wherein each functional unit (10) is adapted to execute operations, characterized in that said functional units (10) are controlled by a plurality of control units (12) wherein at least one control unit (12) is operatively associated to any functional unit (10), respectively, so that each functional unit (10) is able to execute operations in an autonomous manner under control by the control unit (12) associated thereto.

11. Method according to claim 9, characterized in that data-flow communication among said functional units (10) is supported by FIFO (first-in/first-out) register means (14).

12. A method for processing digital signals in a digital signal processing apparatus, comprising a plurality of functional units (10) wherein each functional unit (10) is adapted to execute operations, characterized in that data-flow communication among said functional units (10) is supported by FIFO (first-in/first-out) register means (14).

13. Method according to claim 11 or 12, wherein a pipeline consisting of a plurality of stages is provided, and each stage is executed by a functional unit (10).

14. Method according to at least any one of the claims 10 to 13, character-zed in that the number of times an instruction stored has to be executed by a functional unit (10) is counted by the corresponding control unit (12).

15. Method according to at least any one of the claims 9 to 14, wherein a main program is stored in a program memory means (6), characterized in that said main program contains directives for instructing said control units.
